(19) United States
(12) Patent Application Publication
(10) Pub. No.: US 2020/0041532 A1
(43) Pub. Date: Feb. 6, 2020

(54) REAGENT DISPENSING SYSTEMS

(71) Applicant: HEWLETT-PACKARD DEVELOPMENT COMPANY, L.P., SPRING, TX (US)

(72) Inventors: Heather B. Louderback, Corvallis, OR (US); Diane R. Hammerstad, Corvallis, OR (US); Jeffrey A. Nielsen, Corvallis, OR (US)

(73) Assignee: HEWLETT-PACKARD DEVELOPMENT COMPANY, L.P., SPRING, TX (US)

(21) Appl. No.: 16/603,754

(22) PCT Filed: Jul. 18, 2017
(86) PCT No.: PCT/US2017/042527

§ 371 Date: Oct. 8, 2019

(51) Int. Cl. G01N 35/10

(52) U.S. Cl. CPC G01N 35/1002; G01N 35/0099; G01N 35/1011

(57) ABSTRACT

A reagent deposition area of a reagent dispensing system may include a dispersion bar located above a conveyor system, and a reagent module coupled to the dispersion bar. The reagent module may include at least one reagent dispensing device to dispense a number of reagents on a substrate carried on the conveyor system, and a module frame electrically and mechanically coupling the reagent dispensing device to the reagent dispensing system. The dispersion bar moves the reagent module in two coordinate directions planar with the surface of the substrate.

### BACKGROUND

The life sciences research and associated diagnostic industries use a number of reagents and patient samples to perform testing and diagnostics. Dispensing liquids such as these reagents and patient samples in quantities from picoliters to microliters may be used in many areas of pharmaceutical and biology research. For example, dispensing a number of reagents in these quantities may be useful in medical and veterinary diagnostics, forensics testing, and agricultural testing to determine the presence of a chemical or biological in a sample. Even within these fields, low-volume liquid dispensing may be used for many different operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a reagent dispensing system, according to an example of the principles described herein.

FIG. 2 is a block diagram of a reagent deposition area of a reagent dispensing system, according to an example of the principles described herein.

FIG. 3 is a block diagram of a computer program product for dispensing reagents onto a substrate, according to an example of the principles described herein.

FIG. 4 is a block diagram of a reagent dispensing system, according to another example of the principles described herein.

FIG. 5 is a block diagram of a reagent module, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Human interaction during life science research and diagnostic processes may lead to mistakes in those processes. Such mistakes may decrease the likelihood of scientific breakthroughs and increase the likelihood of misdiagnosis of patient's illnesses. Further, with human interaction, these processes may prove tedious thereby increasing the costs associated with these processes as well as increase the time spent completing the processes. Automation of these processes, however, limits mistakes, time, and costs.

Instruments and tools used in life science research and diagnostic processes have been developed to increase efficiency, decrease costs, and decrease time spent conducting this research or completing diagnosis. However, even with these developments, increased numbers of reagents used to interact with a sample increase the complexity and time of completing those tasks.

In an automated, computer-driven diagnostics system, reagents may be dispensed based on a number of test protocols, and a wide variety and volumes of different reagents may be dispensed based on these test protocols. However, in some instances, the substrates on which the reagents are dispensed may be large enough such that a stationary reagent dispensing devices may be unable to dispense reagent onto the entirety of the substrate.

The reagents may be dispensed onto a substrate such as, for example, microscope slides containing biological samples for research or medical diagnoses using the reagent dispensing devices. In order to properly dispense the reagents on various portions of the substrate, the reagent dispensing devices may move in at least two coordinate directions to the edges of the substrate.

Examples described herein provide a reagent dispensing system. The reagent dispensing system may include at least one reagent module. The reagent module may include at least one reagent dispensing device to dispense a number of reagents on a substrate, and a module frame electrically and mechanically coupling the reagent dispensing device to the reagent dispersing system. The reagent module may also include a conveyor system on which a number of substrates are conveyed underneath the reagent module, and a dispersion bar within a deposition area and located above the conveyor system. The reagent module is coupled to the dispersion bar when placed in the deposition area, and the dispersion bar moves the reagent module in two coordinate directions planar with a surface of the substrate.

In one example, the conveyor system moves in positive and negative x-coordinate directions, and the dispersion bar moves the reagent module in positive and negative x- and y-coordinate directions over the conveyor system, The reagent dispensing system may include a controller to control the movement of the conveyor system and the dispersion bar relative to one another. The at least one reagent dispensing device dispenses a plurality of reagents.

In one example, the reagent dispensing system may include an automated storage and retrieval system (ASRS) to exchange a first reagent module located in the deposition area of the reagent dispensing system with a second reagent module located in a storage zone of the reagent dispensing system. The storage zone of the reagent dispensing system stores a number of deck trays supporting a number of reagent modules not located in the deposition area. The deck trays are removable from the storage zone of the reagent dispensing system. The ASRS may include a robotic arm system, a conveyor rail system, a horizontal carousel module, a vertical carousel module, a grid storage system, vertical lift modules, or combinations thereof. The reagent dispensing system may also include at least one environmentally-controlled area within the reagent dispensing system to preserve a number of reagents within the reagent modules. At least one of the number of deck trays is located in the environmentally-controlled area, and the reagent modules may be stored in environmentally-controlled areas of the storage zone based on at least one property of a reagent within the reagent modules.

Examples described herein also provide a reagent deposition area of a reagent dispensing system. The reagent deposition area of a reagent dispensing system may include a dispersion bar located above a conveyor system, and a reagent module coupled to the dispersion bar. The reagent module may include at least one reagent dispensing device to dispense a number of reagents on a substrate carried on the conveyor system, and a module frame electrically and mechanically coupling the reagent dispensing device to the reagent dispensing system. The dispersion bar moves the reagent module in two coordinate directions planar with the surface of the substrate.

The conveyor system moves in positive and negative x-coordinate directions, and the dispersion bar moves the reagent modules in positive and negative x- and y-coordinate directions over the conveyor system. The conveyor system and dispersion bar are able to move in positive and negative coordinate directions. The movement of the dispersion bar relative to the conveyor system extends to all portions of the substrate.

The reagent module is exchangeable with an off-line reagent module via an automated storage and retrieval system (ASRS). The ASRS may include at least one conveyance module to convey a number of reagent modules between a deposition area and a storage zone, the reagent modules comprising a module frame electrically and mechanically coupling a number of reagent dispensing devices to a reagent dispersing system, and at least one deck tray to store a number of the reagent modules in the storage zone.

Examples described herein also provide a computer program product for dispensing reagents onto a substrate. The computer program product may include a non-transitory computer readable medium that includes computer usable program code embodied therewith. The computer usable program code may, when executed by a processor move a dispersion bar within a deposition area relative to a conveyor system in positive and negative x- and y-coordinate directions over the conveyor system based on a reagent dispersion pattern, move the conveyor system in positive and negative x-coordinate directions based on the reagent dispersion pattern, and dispense a number of reagents on a substrate conveyed by the conveyor system from a plurality of reagent dispensing devices coupled to the dispersion bar via an in-line reagent module. The computer program product may include computer usable program code to, when executed by the processor, replace the in-line reagent module located at a deposition area of a reagent dispensing system, identify a number of reagent resources within an off-line reagent module within a storage zone of the reagent dispensing system to replace the in-line reagent module, instruct an automated storage and retrieval system (ASKS) to replace the in-line reagent module with the off-line reagent module.

As used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

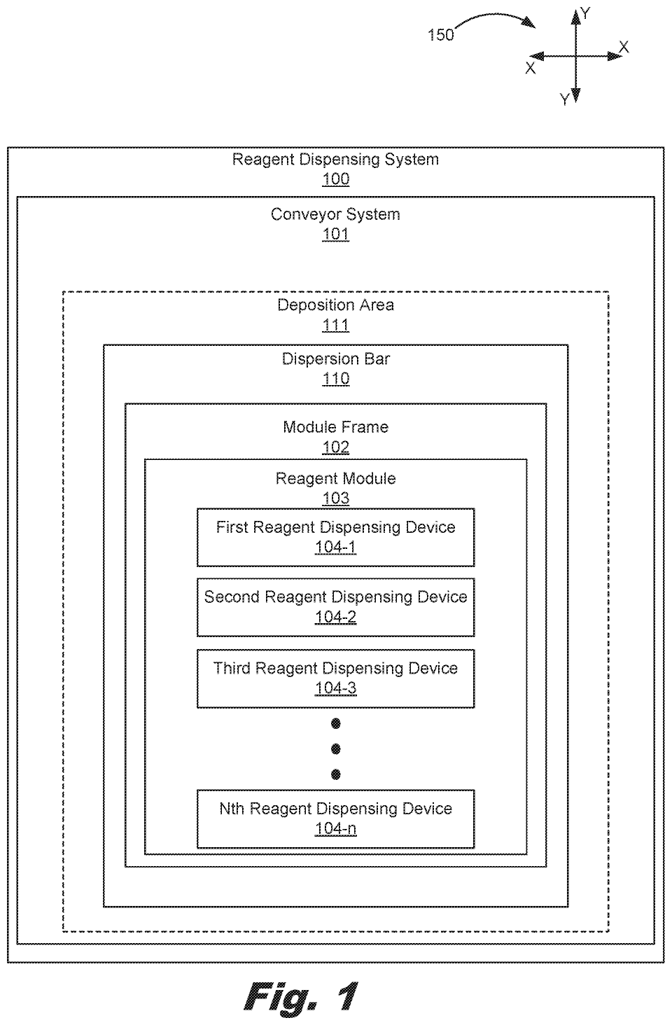

Turning now to the figures, FIG. 1 is a block diagram of a reagent dispensing system (100), according to an example of the principles described herein. The reagent dispensing system (100) may be any system that dispenses a reagent onto a substrate. In one example, the reagent dispensing system (100) is an automated, computer driven system that dispenses, through a number of reagent dispensing devices, a number of different reagents. The reagents may be any chemical or biological substance that may be used in any chemical reaction such as titrations, combinations, decompositions, single displacements, precipitations, neutralizations, double displacements, combustions, and reductions/oxidations, among other types of chemical or biological reactions. The reagents may be, for example, solutions including nucleic acid; deoxyribonucleic acid (DNA); ribonucleic acid (RNA); small (or short) interfering RNA (siRNA); polymerase chain reaction (PCR) master mix; proteins including, for example, enzymes and antibodies; other biomolecules including, for example, peptides, oligos, and lipids; small molecules, nanoparticles, biocides, cells or other tissue components, histology stains, linker reagents, inhibitors, aqueous solutions, or many other reagents.

The reagent dispensing system (100) may include a conveyor system (101) that carries a number of substrates onto which the reagents are dispensed. In this example, the conveyor surface (101) may be a conveyor system on which a number of substrates are conveyed underneath a reagent module (103) located at an in-line position relative to the conveyor system (101) of the reagent dispensing system (100). In one example, the substrates may be microscope slides, test samples, cell-culture dishes such as Petri dishes, paper, tissue samples, porous media, lateral flow strip media, coated media, microtiter plates, or other substrates.

In one example, the reagent module (103) may be exchanged for another reagent module (103). In this example, a number of reagent modules (103) may be located off-line with respect to the conveyor system (101) and a deposition area (111), and may contain reagents within their respective reagent dispensing devices (104) that differ from those in the reagent modules (103) located in-line at the deposition area (111). In one example, the reagent modules (103) positioned at the deposition area (111) may be exchanged by hand by, for example, a technician overseeing the processes performed by the reagent dispensing system (100). In another example, the reagent modules (103) positioned at the deposition area (111) may be exchanged using an automated system that utilizes tracks, robotic devices, carousels, conveyor systems, other transport systems, or combinations thereof to exchange an in-line reagent module (103) with an off-line reagent module (103).

The reagent module (103) may include a module frame (102) to mechanically and electrically couple the reagent dispensing devices (104) within the reagent module (103) to the reagent dispensing system (100). The module frame (102) may include a number of mechanical interfaces to align the reagent dispensing devices (104) with respect to the reagent module (103). Further, the module frame (102) may include a number of electrical interfaces to electrically couple the reagent dispensing devices (104) to the reagent module (103), and, in turn, the reagent dispensing system (100). Signals may be sent by the reagent dispensing system (100) to the reagent dispensing devices (104) via the number of electrical interfaces of the reagent module (103). These signals may be used to instruct the reagent dispensing devices (104) to disperse a volume of reagent onto a substrate located on the conveyor system (101). The module frame (102) is described in more detail herein.

Each of the reagent dispensing devices (104-1, 104-2, 104-3, 104-n, collectively referred to herein as 104) may be any device that dispenses a number of reagents. In one example, the reagent dispensing devices (104) may each dispense a plurality of reagents.

In one example, the reagent dispensing devices (104) may include devices that dispense different volumes of reagents, For example, a first reagent dispensing device (104-1) may dispense a first range of volumes of a reagent, a second reagent dispensing device (104-2) to dispense a second range of volumes of a reagent where the second range of volumes may be more voluminous relative to the first range of volumes, and a third reagent dispensing device (104-3) to dispense a third range of volumes of a third reagent where the third range of volumes may be more voluminous relative to the second range of volumes.

As depicted using the ellipses in FIG. 1 and the inclusion of an Nth reagent dispensing device (104-n), any number of reagent dispensing devices may be included within a reagent module (103). Each of these reagent dispensing devices (104-1, 104-2, 104-3, 104-n, collectively referred to herein as 104) may have differing architectures or form factors that allow them to dispense their respective volumes. For example, the first reagent dispensing device (104-1) may include a cassette device that dispenses between approximately 1 picoliter (pL) and 10 microliters (μL) as the first range of volumes of a reagent. The cassette may include, for example, a T8+ or D4+ dispensehead cassette produced and distributed by HP, Inc. With these types of cassettes, a relatively small amount of reagent may be dispensed at a given time. In one example, the first reagent dispensing device (104-1) or cassette may be any digitally addressable fluid ejection device that contains a very small amount of reagent on the order of approximately up to 1 milliliter. Further, the fluid within the first reagent dispensing device (104-1) may come pre-filled in the first reagent dispensing device (104-1), or a technician may fill the first reagent dispensing device (104-1) with a pipette or similar preliminary, manual reagent dispensing device at the time of use of the first reagent dispensing device (104-1).

Further, in one example, the second reagent dispensing device (104-2) may include a digitally addressable fluid ejection device. In this example, the digitally addressable fluid ejection device may include a number of fluid ejection die to dispense the second range of volumes of a reagent. For example, the second reagent dispensing device (104-2) may include a digitally addressable fluid ejection device that dispenses between approximately 100 nanoliters (nL) and 100 μL as the second range of volumes of a reagent. In one example, the digitally addressable fluid ejection device may be a thermal or piezoelectric fluid ejection device where the reagents are dispensed from an array of fluid ejection chambers and nozzles of the fluid ejection die using thermal expansion or piezoelectric forces applied to the reagents. In this example, the second reagent dispensing device (104-2) may contain, for example, 1 to 40 milliliters of reagent and may be pre-packaged with the reagent before the time of use.

Still further, in one example, the third reagent dispensing device (104-3) may include any high-volume reagent dispensing device such as, for example, a digitally addressable fluid ejection device fluidically coupled to an off-line bulk supply of reagent. In this example, the third reagent dispensing device (104-3) may be used in connection with the dispensing of bulk amounts of reagents. The third reagent dispensing device (104-3) may include a digitally addressable fluid ejection device that dispenses between approximately 100 nanoliters (nL) and 100 μL as the third range of volumes of a reagent. In this example, the third reagent dispensing device (104-3) may contain bulk volumes of reagent since this bulk reagent dispensing device may be used most often, Thus, third reagent dispensing device (104-3) may contain for example, 40 to 1,000 mL of reagent and may be pre-packaged with the reagent before the time of use.

With regard to the reagent dispensing devices (104-1, 104-2, 104-3, 104-n), a frequency of use and amount of dispersion of respective reagents within a given time period may be taken into consideration in determining what reagents are placed in what type of architecture of reagent dispensing devices (104-1, 104-2, 104-3, 104-n). For example, for reagents that are utilized relatively more often and/or at higher dispensed volumes, the third reagent dispensing device (104-3) may be used. In this example, the third reagent dispensing device (104-3) may contain reagents used daily, with dispense volumes ranging from approximately 100 nL to 100 μL. In one example, the third reagent dispensing device (104-3) may be fluidically coupled to the off-line bulk supply of reagent to allow for larger volumes of its reagent to be made available to the third reagent dispensing device (104-3).

Further, for reagents that are utilized relatively less often and/or at lower dispensed volumes relative to the third reagent dispensing device (104-3), the second reagent dispensing device (104-2) may be used, In this example, the second reagent dispensing device (104-2) may contain reagents used regularly with dispense volumes met by a fill volume of the second reagent dispensing device (104-2). The second reagent dispensing device (104-2) may be utilized for reagents used weekly to daily, with dispense volumes ranging from approximately 0.5 mL to 20 mL per month.

Still further, for reagents that are utilized relatively less often and/or at lower dispensed volumes relative to the second and third reagent dispensing device (104-2, 104-3), the first reagent dispensing device (104-1) may be used. In this example, the first reagent dispensing device (104-1) may contain reagents used intermittently or rarely with low dispense volumes of the reagent. The first reagent dispensing device (104-1) may be utilized less often than weekly, and for dispense volumes ranging from approximately 10 pL to 0.5 mL per month.

In this manner, the types of architectures had by the reagent dispensing devices (104-1, 104-2, 104-3, 104-n) may be individually utilized based on their dispensing volumes, their capacities, and their frequency of use. A reagent dispensing system (100) that permits for multiple architectural types of reagent dispensing devices (104-1, 104-2, 104-3, 104-n) provides for efficient management and use of reagents that vary widely in terms of their dispensing environmental conditions and their usage rate. Further, the dispensing of reagents in the manner provided by the reagent dispensing devices (104-1, 104-2, 104-3, 104-n) provides a more effective level of control as to amounts of reagents dispensed, and is easier to use relative to, for example, pipette-based methods of reagent dispensing. Further, the reagent dispensing devices (104-1, 104-2, 104-3, 104-n) allow for a more precise placement of reagents on a substrate, including onto specific regions of a tissue sample, for example. Still further, reagents dispensed by the reagent dispensing devices (104-1, 104-2, 104-3, 104-n) may be used with significantly improved efficiency since less reagents are wasted during dispensing. In one example, this increased in efficiency may be as high as 1,000 time more efficient. Even still further, the reagent dispensing devices (104-1, 104-2, 104-3, 104-n) easily combine reagents on the substrate in a digitally addressed manner such that, for example, multiple reagents may be dispensed next to one another or at the same location, as desired.

In one example, each reagent module (103) may include a single reagent dispensing device (104-1, 104-2, 104-3, 104-n), and, in this example, a number of reagent modules (103) may be exchanged with one another to an in-line position relative to the dispersion surface (101), or exist in a number of stations (102) in-line with the dispersion surface (101). The reagent modules (103), in this example, may dispense with their respective single reagent dispensing devices (104-1, 104-2, 104-3, 104-n), their respective volumes. Provisioning of a single reagent dispensing device (104-1, 104-2, 104-3, 104-n) within a reagent module (103) assists in ensuring that the reagents within the reagent dispensing devices (104-1, 104-2, 104-3, 104-n) are not cross-contaminated or cause an unexpected reaction off-line if they were grouped as a plurality of reagent dispensing devices (104-1, 104-2, 104-3, 104-n) within a reagent module (103). In another example, a plurality of the reagent dispensing devices (104-1, 104-2, 104-3, 104-n) may be grouped in a reagent module (103) based on the reagents contained in the reagent dispensing devices (104-1, 104-2, 104-3, 104-n) not having an affinity to react with one another or cross-contaminate one another.

The reagent dispensing system (100) of FIG. 1 may further include a dispersion bar (110). The dispersion bar (110) may be located within the deposition area (111) and above the conveyor system (101). The reagent module (103) and its module frame (102) and reagent dispensing devices (104) are coupled to the dispersion bar (110) when placed in the deposition area (111). The dispersion bar (110) moves in at least two coordinate directions planar to a surface of the substrates presented on the conveyor system (101). With the reagent module (103) coupled to the dispersion bar (110), the reagent module (103) is also able to move with the dispersion bar (110) in at least two coordinate directions planar to a surface of the substrates. In this manner, the reagent module (103) may be able to reach and deposit reagent on more area of the substrate than a linear area below a stationary position of the reagent dispensing devices (104) of the reagent modules (103). In some examples, with the use of the dispersion bar (110) and its ability to move in two coordinate directions planar to a surface of the substrates, reagent may be dispensed on any and all portions of the substrate. This type of movement of the dispersion bar (110) makes dispensing of the reagents within, for example, a microtiter plate possible, but also provides for any number of types of reagents and volumes of reagent to be dispensed within the wells of the microtiter plate,

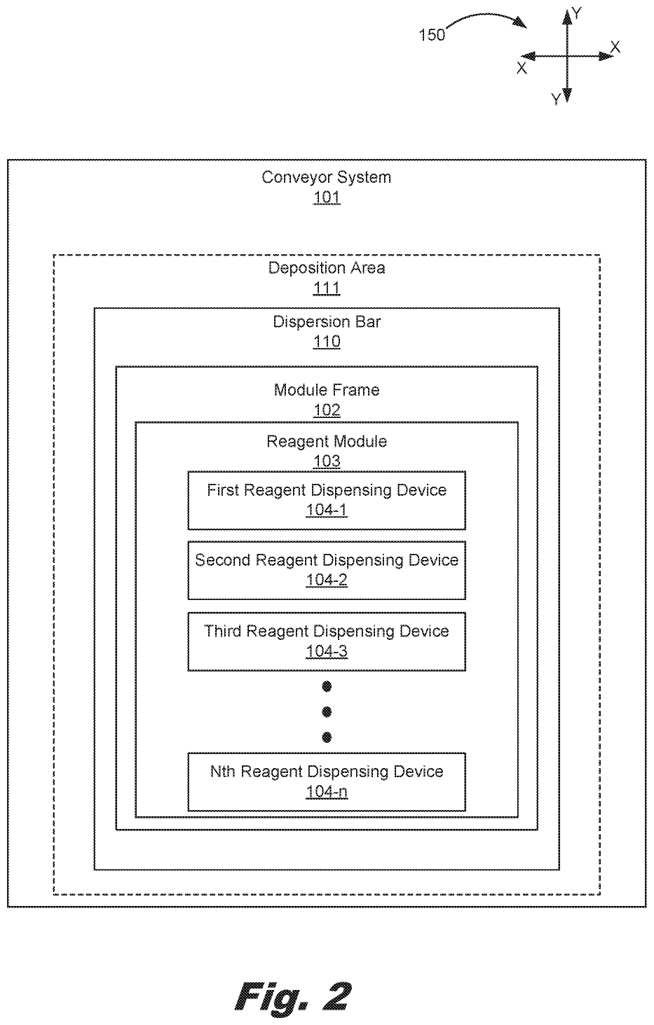

FIG. 2 is a block diagram of a reagent deposition area (111) of a reagent dispensing system (100), according to an example of the principles described herein. Similarly-numbered elements included in FIG. 1 and described in connection with FIG. 1 designate similar elements within FIG. 2. The reagent deposition area (111) may include a dispersion bar (110) located above a conveyor system (101), and a reagent module (103) coupled to the dispersion bar (110). The reagent module (103) may include at least one reagent dispensing device (104) to dispense a number of reagents on a substrate carried on the conveyor system (101). The reagent module (103) may also include a module frame (102) electrically and mechanically coupling the reagent dispensing device (104) to the reagent dispensing system (100). As described herein, the dispersion bar (110) is capable of moving the reagent module (103) in two coordinate directions planar with the surface of the substrate to allow for a number of reagents to be dispensed on any and all portions of the surface of the substrate. A coordinate indicator (150) is depicted in FIG. 2. With reference to the coordinate indicator (150), the conveyor system (101) is able to move substrates positioned thereon in the positive and negative x-directions. The dispersion bar (110) is able to move the coupled reagent module (103) through coupling to the reagent module's (103) module frame (102) in both the positive and negative x-directions as well as the positive and negative y-directions.

In another example, the dispersion bar (110) may be able to move the coupled reagent module (103) in the positive and negative y-direction with the conveyor system (101) moving in the positive and negative x-direction, In this example, the movement and associated devices of the dispersion bar (110) and the conveyor system (101) are made simpler while still allowing a number of reagents to be dispensed on an entirety of the substrate.

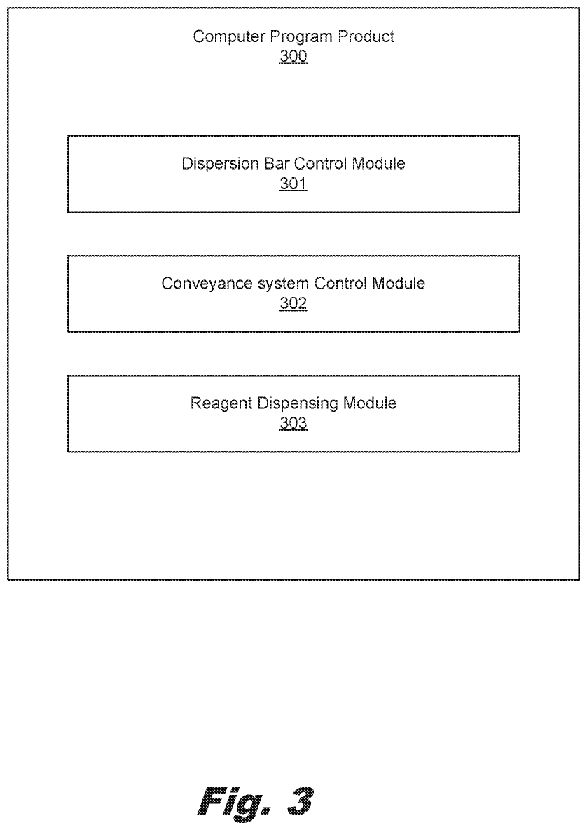

FIG. 3 is a block diagram of a computer program product (300) for dispensing reagents onto a substrate, according to an example of the principles described herein. The computer program product (300) may include a non-transitory computer readable medium. The computer readable medium may include computer usable program code embodied therewith. The computer usable program code, when executed by a processor, moves the dispersion bar (110) within a deposition area (111) relative to a conveyor system in positive and negative x- and y-coordinate directions over the conveyor system (101) based on a reagent dispersion pattern. The computer program product (300) may do so through the execution of a dispersion bar control module (301) that, when executed by a processing device, instructs the dispersion bar (110) to move as instructed in order to dispense reagent onto a substrate in a desired pattern.

A conveyance system control module (302) may be included within the computer program product (300) as computer usable program code. When executed by a processing device, the conveyance system control module (302) may control the movement of the conveyance system (101) in the positive and negative x-coordinate directions based on the reagent dispersion pattern.

The computer program product (300) may further include a reagent dispensing module (303) to, when executed by the processing device, instruct at least one of the reagent dispensing devices (104) within the reagent module (103) to dispense a volume of the reagent onto the substrate.

In one example, the computer program product may also include computer usable program code to, when executed by the processor, replace the in-line reagent module (103) located at a deposition area (111) of a reagent dispensing system (100), identify a number of reagent resources within an off-line reagent module (103) within a storage zone of the reagent dispensing system (100) to replace the in-line reagent module (103), and instruct an automated storage and retrieval system (ASRS) to replace the in-line reagent module (103) with the off-line reagent module (103). The ASRS (420) may include any number of conveyor systems, lift systems, robotic arms, other ASRS systems, and combinations thereof. In another example, a technician may manually exchange the reagent modules (103), In another example, the in-line reagent module (103-2) may be exchanged for an off-line reagent module (103-1, 103-3) by a user such as a technician manually exchanging the reagent modules (103).

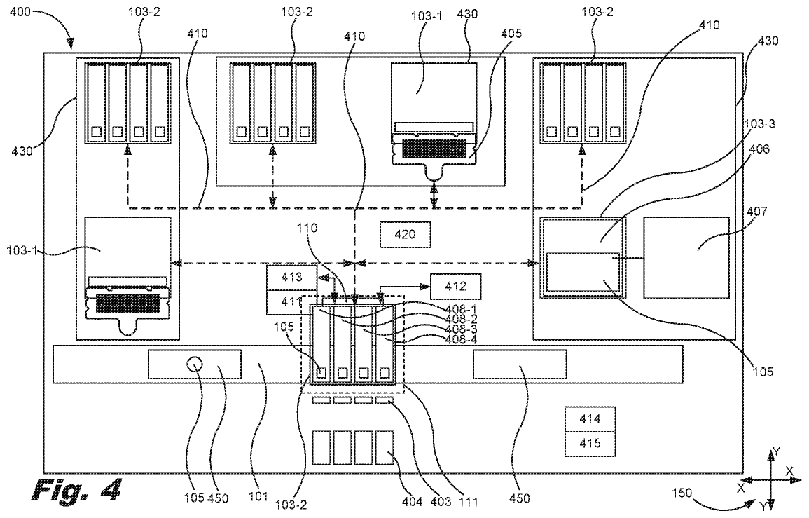

FIG. 4 is a block diagram of a reagent dispensing system, according to another example of the principles described herein. The reagent dispensing system (400) may include a number of elements including the reagent dispensing system (100) and its various elements described in connection with FIGS. 1 through 3. Therefore, similarly-numbered or similarly-named elements included in FIGS. 1 through 3 and described in connection with FIGS. 1 through 3 designate similar elements within the reagent dispensing system (400) of FIG. 4. As depicted in FIG. 4, a reagent module (103) is located within a deposition area (111) of the reagent dispensing system (400) and is considered to be in an in-line position to dispense reagent (105) onto a number of substrates (450). In this manner, the reagent modules (103) may be physically coupled to the reagent dispensing system (400) and be seated within the deposition area (111) in order to dispense reagent (105) onto the substrates (450).

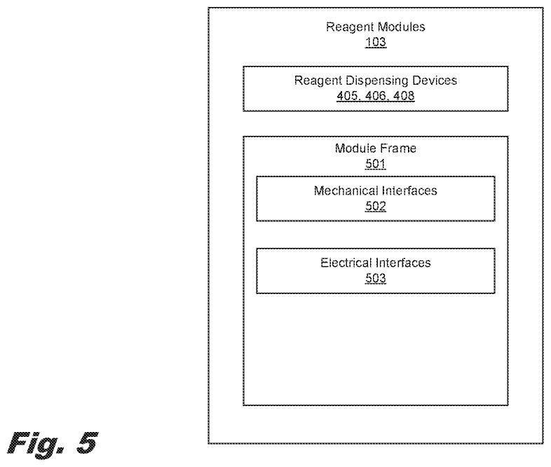

Further, FIG. 5 is a block diagram of a reagent module (103), according to an example of the principles described herein and will be described herein in connection with FIG. 4. In this physically coupled state where the reagent modules (103) are physically coupled to the reagent dispensing system (400), a number of electrical interfaces (503) located on the reagent modules (103) electrically interface with the electrical interfaces (412) located in the deposition area (111) of the reagent dispensing system (400). This allows the reagent dispensing system (400) to send instructions in the form of signals to the modules (103) that cause the various reagent dispensing devices (405, 406, 408) to dispense their respective reagents (105) onto the substrates (450).

A processing device (414) and a data storage device (415) may be included in the reagent dispensing system (400) to instruct and store data about the reagent modules (103) and their respective reagent dispensing devices (405, 406, 408). In one example, the computer program products (103) described herein may be stored in the data storage device (415), and provided to the processing device (414) for execution by the processing device (414). The processing device (414) may provide signals to the reagent dispensing devices (405, 406, 408) to instruct the reagent dispensing devices (405, 406, 408) to dispense their respective reagents (105) onto the substrates (450). Further, the processing device (414) may instruct the ASRS (420) to exchange the in-line reagent module (103) with an off-line reagent module (103) in order to dispense a different reagent or volume of reagent.

The processing device (414) may further provide instructions to the conveyor surface (101) as to speed and direction in moving the substrates (450) within the deposition area (111) and under the reagent modules (103). Still further, the processing device (414) may instruct the dispersion bar (110) as to speed and direction of movement of the reagent module (103) over the conveyor surface (101). Again, the conveyor system (101) is able to move substrates positioned thereon in the positive and negative x-directions as indicated by the coordinate indicator (150), and the dispersion bar (110) is able to move the coupled reagent module (103) through coupling to the reagent module's (103) module frame (102) in both the positive and negative x-directions as well as the positive and negative y-directions as indicated by the coordinate indicator (150).

The data storage device (415) may include various types of memory modules, including volatile and nonvolatile memory. For example, the data storage device (415) of the present example may include Random Access Memory (RAM), Read Only Memory (ROM), and Hard Disk Drive (HDD) memory. Many other types of memory may also be utilized, and the present specification contemplates the use of many varying type(s) of memory in the data storage device (415) as may suit a particular application of the principles described herein. In certain examples, different types of memory in the data storage device (415) may be used for different data storage needs. For example, in certain examples the processing device (414) may boot from Read Only Memory (ROM), maintain nonvolatile storage in the Hard Disk Drive (HDD) memory, and execute program code stored in Random Access Memory (RAM). The data storage device (415) may comprise a computer readable medium, a computer readable storage medium, or a non-transitory computer readable medium, among others, For example, the data storage device (415) may be, but not limited to, an electronic, magnetic, optical, electromagnetic, infrared, or semiconductor system, apparatus, or device, or any suitable combination of the foregoing, More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device. The data storage device (415) may store computer usable program code described herein for execution by the processing device.

As depicted in FIG. 4, the conveyor surface (101) may move in a positive x-direction or a negative x-direction to move the substrates (450) underneath the reagent modules (103) as indicated by arrow (220) in order to dispense reagent (105) onto the substrates (450). Further, the reagent modules (103) may move perpendicular to the direction of the movement of the conveyor surface (101) in order to service and protect the reagent dispensing devices (104) within the reagent module (103) in ways other than performing the spitting operation, For example, the reagent dispensing system (400) may include a wiping station (403) to wipe off or clean the reagent dispensing devices (104) of the reagent module (103), In one example, the wiping station (403) wipes a nozzle plate or other ejection surface of the at least one reagent dispensing device (104) within the reagent module (103). The reagent dispensing system (400) may also include a capping station (404) to seal a number of nozzles or other ejection devices of the at least one reagent dispensing device (104) from ambient atmosphere around the deposition area (111).

The in-line reagent module (103) in the example of FIG. 4 includes a number of different reagent modules (103-1, 103-2, 103-3, collectively referred to herein as 103) that include differing architectures or form factors that allow them to dispense their respective volumes. For example, the reagent module (103-2) located within the reagent deposition area (402) includes four digitally addressable fluid ejection devices (408-1, 408-2, 408-3, 408-4, collectively referred to herein as 408). In one example, the four digitally addressable fluid ejection devices (408) may each include a volume of reagent (105). The reagent module (103-2) including the digitally addressable fluid ejection devices (408) may dispense an average or mid-range amount of reagent (105), and may be used for dispensing reagents that are dispensed at an average or mid-range frequency.

Other reagent modules (103-1, 103-2, 103-3) may be stored or placed off-line, and may be exchangeable with the in-line reagent module (103-2). Other architectures or form factors of reagent modules (103) may be included within the reagent dispensing system (400). Another architecture or form factor of reagent modules (103) may include a reagent module (103-1) that includes a cassette device (405). As described herein, the cassette device (405) may dispense between approximately 0.1 picoliters (pL) and 0.1 microliters (μL) as the first range of volumes of a reagent. The first range of volumes is less than the volumes that may be dispensed using the digitally addressable fluid ejection devices (104-2). The cassette device (405) may include, for example, a T8+ or D4+ dispensing cassette produced and distributed by HP, Inc. With these types of cassettes, a relatively small amount of reagent may be dispensed at a given time using a dispensing die that is capable of dispensing these relatively small volumes of fluid. The cassette device (405) may be used to dispense volumes of fluid that are less frequently dispensed relative to other reagents, are negatively susceptible to environmental conditions, are expensive to inventory, are mixed immediately before use, have a relatively short shelf life, have other properties that lend their use to relatively smaller volumes, or combinations thereof.

Another architecture or form factor of reagent modules (103) may include a reagent module (103-3) that includes a bulk reagent dispensing device (406). The bulk reagent dispensing device (406) may be fluidically coupled to a bulk reagent source (407) to provide the bulk reagent dispensing device (406) with ample reagent to dispense. The reagent module (103-3) including the bulk reagent dispensing device (406) may dispense a bulk or high-range amount of reagent (105), and may be used for dispensing reagents that are dispensed at above average frequencies.

Thus, the cassette device (405) of the reagent module (103-1) may dispense a first range of volumes. The digitally addressable fluid ejection devices (408) of the reagent module (103-2) may dispense a second range of volumes where the second range of volumes may be more voluminous relative to the first range of volumes. The bulk reagent dispensing device (406) of the reagent module (103-3) may dispense a third range of volumes where the third range of volumes may be more voluminous relative to the second range of volumes. Further, the cassette device (405) of the reagent module (103-1) may be utilized in dispensing reagents that are rarely or less-frequently dispensed. The digitally addressable fluid ejection devices (408) of the reagent module (103-2) may be utilized in dispensing reagents that are dispensed at an average frequency or at least more frequently than those reagents dispensed by the cassette device (405) of the reagent module (103-1). The bulk reagent dispensing device (406) of the reagent module (103-3) may be utilized in dispensing reagents that are very frequently used or at least more frequently used then those reagents dispensed by the digitally addressable fluid ejection devices (408) of the reagent module (103-2).

In one example, the computer usable program code of the computer program product (300) may send data regarding the positions and speeds of the conveyor surface (101) and any substrates (450) placed thereon. Further, the computer usable program code of the computer program product (300) may send data regarding the position and speed of movement of the dispersion bar (110). Still further, the computer usable program code of the computer program product (300) may send data regarding the relative positions and speeds of movement of the conveyor surface (101) and the dispersion bar (110). With this information, the processing device (414) may digitally address the deposition of reagents on any portion of the substrate (450).

FIG. 4 also depicts a number of removable deck trays (430), The deck trays (430) that house a plurality of swappable reagent modules (103) that may be exchanged using the ASRS (420), The deck trays (430) may each be removable by a user from the reagent dispensing system (400). In one example, a user may prepare the reagent dispensing system (400) for a plurality of tests to be conducted by the reagent dispensing system (400) by selecting specific reagents to be used in connection with specific tests. As an example, a user may prepare the reagent dispensing system (400) to conduct a specific test by selecting, in the example shown in FIG. 4, up to 4 different reagent dispensing devices (104) comprising up to four different reagents, The reagent dispensing devices (104) may then be placed within a swappable reagent module (103). The swappable reagent module (103) may then be placed within one of the deck trays (430) and the deck trays (430) may be placed within the storage area of the reagent dispensing system (400) off-line from the deposition area (111). During operation of the reagent dispensing system (400), the reagent dispensing system (400) may detect an identification placed on the reagent dispensing devices (405, 406, 408) and/or swappable reagent modules (103), determine which reagents are held within the reagent dispensing devices (104), and assign or otherwise associate those reagents and, consequently, those reagent dispensing devices (104) and swappable reagent modules (103) to specific tests that are to be conducted by the reagent dispensing system (400). In an example, the user, via a user interface on the reagent dispensing system (400), may assign specific swappable reagent modules (103) and their respective reagent dispensing devices (104) to a specifically selected test. Additionally, the user may be provided with a graphical user interface that describes the reagents housed within each of the reagent dispensing devices (104) as well as how each of the reagent dispensing devices (104) may be grouped into any number of swappable reagent modules (103).

In one example, the reagent dispensing system (400) may include at least one environmentally-controlled area within the reagent dispensing system to preserve a number of reagents within the reagent modules. In one example, at least one of the number of deck trays (430) is located in the environmentally-controlled area, and the reagent modules (103) are stored in environmentally-controlled areas of the storage zone based on at least one property of a reagent within the reagent modules. In this example, the deck trays (430) may form a portion of the environmentally-controlled area. Many reagents dispensable by the reagent modules (103) may have a shelf life or may perform better in a reaction if they are stored in an area where its environment may be controlled. The environmentally-controlled areas (430) may be environmentally sealed from the remainder of the reagent dispensing system (400), and may control, for example, a humidity level, a temperature, a pressure, or other environmental states within the reagent dispensing system (400).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processing device (414) of the reagent dispensing system (100, 400) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a reagent deposition area of a reagent dispensing system may include a dispersion bar located above a conveyor system, and a reagent module coupled to the dispersion bar. The reagent module may include at least one reagent dispensing device to dispense a number of reagents on a substrate carried on the conveyor system, and a module frame electrically and mechanically coupling the reagent dispensing device to the reagent dispensing system. The dispersion bar moves the reagent module in two coordinate directions planar with the surface of the substrate. This reagent dispensing system may provide a technician with the ability to dispense reagent on any portion of s substrate to allow all portions of the substrate to be used for diagnostics and testing.

The preceding description has been presented to illustrate and describe examples of the principles described. This description is not intended to be exhaustive or to limit these principles to any precise form disclosed. Many modifications and variations are possible in light of the above teaching.

What is claimed is:

1. A reagent dispensing system comprising:
at least one reagent module comprising:
at least one reagent dispensing device to dispense a number of reagents on a substrate; and
a module frame electrically and mechanically coupling the reagent dispensing device to the reagent dispersing system;
a conveyor system on which a number of substrates are conveyed underneath the reagent module; and
a dispersion bar within a deposition area and located above the conveyor system,
wherein the reagent module is coupled to the dispersion bar when placed in the deposition area, and
wherein the conveyor system moves in positive and negative x-coordinate directions.

2. The reagent dispensing system of claim 1, wherein the dispersion bar moves the reagent module in positive and negative x- and y-coordinate directions planar with the surface of the substrate over the conveyor system.

3. The reagent dispensing system of claim 1, comprising a controller to control the movement of the conveyor system and the dispersion bar relative to one another.

4. The reagent dispensing system of claim 1, wherein the at least one reagent dispensing device dispenses a plurality of reagents.

5. The reagent dispensing system of claim 1, comprising an automated storage and retrieval system (ASRS) to exchange a first reagent module located in the deposition area of the reagent dispensing system with a second reagent module located in a storage zone of the reagent dispensing system.

6. The reagent dispensing system of claim 5, wherein the storage zone of the reagent dispensing system stores a number of deck trays supporting a number of reagent modules not located in the deposition area.

7. The reagent dispensing system of claim 6, wherein the deck trays are removable from the storage zone of the reagent dispensing system.

8. The reagent dispensing system of claim 5, wherein the ASRS comprises a robotic arm system, a conveyor rail system, a horizontal carousel module, a vertical carousel module, a grid storage system, vertical lift modules, or combinations thereof.

9. The reagent dispensing system of claim 1, comprising at least one environmentally-controlled area within the reagent dispensing system to preserve a number of reagents within the reagent modules,
wherein at least one of the number of deck trays is located in the environmentally-controlled area, and
wherein the reagent modules are stored in environmentally-controlled areas of the storage zone based on at least one property of a reagent within the reagent modules. 10, A reagent deposition area of a reagent dispensing system comprising:
a dispersion bar located above a conveyor system;
a reagent module coupled to the dispersion bar, the reagent module comprising:
at least one reagent dispensing device to dispense a number of reagents on a substrate carried on the conveyor system; and
a module frame electrically and mechanically coupling the reagent dispensing device to the reagent dispensing system,
wherein the conveyor system moves in positive and negative x-coordinate directions.

11. The reagent deposition area of claim 10, wherein the dispersion bar moves the reagent modules in positive and negative x- and y-coordinate directions over the conveyor system planar with the surface of the substrate, the conveyor system and dispersion bar moving in positive and negative coordinate directions.

12. The reagent deposition area of claim 11, wherein the movement of the dispersion bar relative to the conveyor system extends to all portions of the substrate.

13. The reagent deposition area of claim 10, wherein the reagent module is exchangeable with an off-line reagent module via an automated storage and retrieval system (ASRS), the ASRS comprising:
at least one conveyance module to convey a number of reagent modules between a deposition area and a storage zone, the reagent modules comprising a module frame electrically and mechanically coupling a number of reagent dispensing devices to a reagent dispersing system; and
at least one deck tray to store a number of the reagent modules in the storage zone.

14. A computer program product for dispensing reagents onto a substrate, the computer program product comprising:
a non-transitory computer readable medium comprising computer usable program code embodied therewith, the computer usable program code to, when executed by a processor:
move a dispersion bar within a deposition area relative to a conveyor system based on a reagent dispersion pattern;
move the conveyor system in positive and negative x-coordinate directions based on the reagent dispersion pattern; and
dispense a number of reagents on a substrate conveyed by the conveyor system from a plurality of reagent dispensing devices coupled to the dispersion bar via an in-line reagent module.

15. The computer program product of claim 14, wherein moving the dispersion bar within the deposition area relative to the conveyor system based on a reagent dispersion pattern comprises moving the dispersion bar in positive and negative x- and y-coordinate directions.
